(19) United States
(12) Patent Application Publication
(10) Pub. No.: US 2006/0219823 A1
(43) Pub. Date: Oct. 5, 2006

(54) Spray conduit and cap having a 90° offset spray conduit for an aerosol can or a spray can

(76) Inventor: Heiko Eberhardt, Oberursel (DE)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/291,212

(22) Filed: Dec. 1, 2005

(30) Foreign Application Priority Data
Dec. 1, 2004 (DE) 10 2004 057 920.2

(51) Int. Cl. B05B 1/14

(52) U.S. Cl. 239/590; 239/337; 239/590.3; 239/590.5

(57) ABSTRACT

In order to attain a pleasant noise in the case of a spray conduit (10), especially one that is integrated in a cap (7) that has a button (6) and a 90° offset spray conduit (10), it is proposed that the spray conduit (10) have a texture on its inner surface that affects the discharge of a product so that a special discharge noise is achieved.

The invention relates to containers for spraying product and involves, on the one hand, a spray conduit for spraying the product, especially hair spray, having a device for affecting the spray noise, a texture being provided on the inner surface of the spray conduit in order to affect the discharge behavior of the product. A spray noise that is pleasant for a consumer is advantageous for him primarily in the case of a container to be used within the range of hearing. On the other hand, the invention relates to a cap having a spray bracket integrated in the cap that surrounds a 90° offset spray conduit, having a button for actuating a valve of a container, especially an aerosol can or spray can, the button being provided to act against a stem of the container via the 90° offset spray conduit in order to deflect the stem when the button is manually actuated and, thus, open the valve. In this way, it is possible for product contained in the can to exit through the stem and a product discharge opening provided on the cap while passing through the spray conduit, the spray conduit being acoustically affected in such a manner that the spray noise is changed. A noise modification inside the cap is particularly expedient in a cap having a corresponding resonance space.

A spray conduit of this type and a cap of this type are known from WO 01/96210 A2. Grooves in an adapter of a valve housing are used to form a flow conduit within a container (FIGS. 58 and 59 of the publication) in order to achieve a certain target tone.

The known technology has the disadvantage that the resonance in the full container undergoes a relatively high dampening. Also, the relatively coarse texture of the inner surface of the spray conduit is not optimal for all container designs or products.

Thus, the object of the present invention is to provide a solution for this disadvantage.

The object is achieved by providing the spray conduit with the texture in the area of the cap. In this context, the spray conduit is designed as a spray bracket that surrounds a 90° offset spray conduit (Claim 1). The spray conduit is located within the cap and in its textured version produces a pleasant spray noise with corresponding resonance inside the cap. A very good result is achieved in principle if the texture is a microstructure (Claim 3). However, a structure that comprises a plurality of flow ribs that are aligned parallel to each other in the direction of flow (Claim 2) also delivers very good acoustic results. In particular a surface that is roughened, embossed, eroded or provided with a crackled lacquer in the interior of the spray channel is suitable as a microstructure (Claim 4). However, the microstructure could also be designed as sharkskin, as lotus leaf surface or as another surface, e.g. coated with PTFE (polytetrafluorethylene), as a permanent oil coating or in some other way. In a microstructure, the structure, e.g. a rhomboid structure, may be oriented in the direction of flow in order to achieve a greater effect. All these measures lead to a reduction of the flow resistance in the case of aerosol sprays and foams. The aerosol products, which are under a delivery pressure, are contained in aluminium or tin-plated aerosol pressure vessels. In order to expel the product, the valve, which is located in a valve plate, is triggered, causing the aerosol to leave the can while releasing pressure and noise. In so doing, the aerosol first flows out of the can into the valve. Then, the aerosol flows through the valve stem into a feed line (in the case of hair spray, this is the spray conduit) and through a nozzle (insert in the case of hair spray).

The valve and the spray lever, or the feed line are flow resistances. They consume energy and produce noises. Both of these are undesirable.

From the field of aerodynamics, it is known that turbulent and laminar flows against boundary layers may be reduced by the roughness of the walls of the flow container (flow body). In the case of the flow in aerosol cans, this means:
All flow conduits may, for example, be roughened on the interior via sandblasting, roughened via embossing inside the conduit, roughened via structural incorporation of ribs inside the conduit or roughened via tool surfaces inside the conduit.

Due to manufacturing requirements, the corresponding flow conduits must be designed in such a manner that interior machining is possible. This may be accomplished, for example, by injection-molding two halves and subsequently folding them together. Erosion textures may be thus be applied in accordance with VDI 3400, RT 12-45. The textures are supposed to have a maximum height that corresponds to the one turbulent boundary layer.

All textures should be aligned in the direction of flow in order not to produce any additional flow resistance.

The invention is described in detail below with reference to Figures that show two exemplary embodiments: In the drawing:

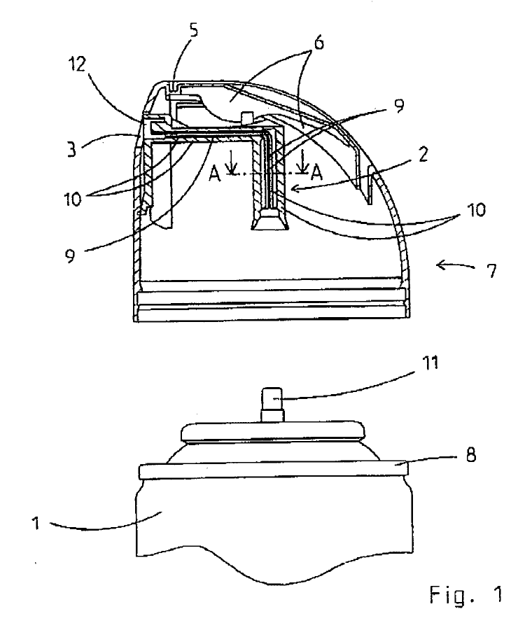

FIG. 1 in a side view with a partial vertical section shows a cap with a button that acts against a spray lever, which contains a 90° offset spray conduit, the cap being placeable on a can, which contains a hair spray, the button not being actuated, and the spray conduit having flow ribs oriented in the direction of flow;

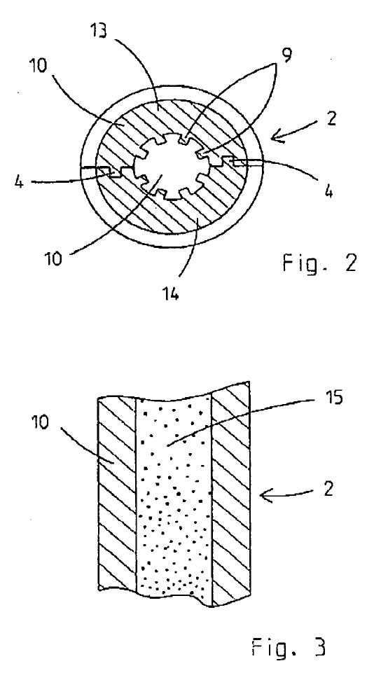

FIG. 2 shows the flow conduit of FIG. 1 in a cross-section along line A-A of FIG. 1, and

FIG. 3 in a longitudinal section shows a vertically aligned spray conduit having a microstructure.

In a cap 7 having a spray bracket 2, which surrounds a 90° offset spray conduit 10 and is integrated in cap 7, a button 6 for actuating a valve of a can 1, which is an aerosol can (FIG. 1). Button 6 is provided for this purpose in order to swivel a hinge 5 and act against a stem 11 of the can 1 via the 90° offset spray conduit 10 in order to deflect the stem 11 when button 6 is manually actuated and in order to thereby open the valve (not shown), whereupon product contained in container 1 is able to exit through stem 11, a nozzle 12 and a product discharge opening 3 provided in cap 7 while passing through spray conduit 10. Spray conduit 10 has a device for affecting the spray noise. To this end, a texture is provided on the inner surface of spray conduit 10 in order to affect the discharge behavior of the product. Spray conduit 10 is designed as a spray bracket 2 that surrounds the 90° offset spray conduit 10. The texture comprises a plurality of flow ribs 9 that are aligned parallel to each other and surround the entire spray conduit 10 from the stem 11 to the product discharge opening 3 with a turbulence-reducing inner surface. Spray conduit 10 comprises two conduit halves 13, 14, that snap together via a plug-in connection 4 (FIG. 2). A two-part design of this type is suitable for all types of applied textures, a longitudinal section being provided in the discharge direction.

In a second exemplary embodiment (FIG. 3) the texture is designed as a microstructure. It has a sharkskin surface.

Both the flow ribs 9 and the microstructure 15 serve to reduce turbulence in the flow conduit 10 and thus achieve a pleasant spray noise.
1 Container
2 Spray lever
3 Product discharge opening
4 Plug-in connection
5 Hinge
6 Button
7 Cap
8 Rim
9 Flow rib
10 Spray conduit
11 Stem
12 Nozzle
13, 14 Conduit half
15 Microstructure

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A spray conduit (10) for spraying a product, especially hair spray, comprising a device for affecting the spray noise, a texture being provided on the inner surface of the spray conduit (10) affecting the discharge behavior of the product, wherein the spray conduit (10) is designed as a spray bracket (2), which surrounds the 90° offset spray conduit (10).

2. The spray conduit as described in claim 1, wherein the texture comprises a plurality of flow ribs (9) that are aligned parallel to each other in the direction of flow.

3. A spray conduit (10) for spraying out a product, especially hair spray, comprising a device for affecting the spray noise, a texture being provided on the inner surface of the spray conduit (10) affecting the discharge behavior of the product, wherein the texture is a micro structure (15).

4. The spray conduit as described in claim 3, wherein the microstructure (15) comprises a surface that is roughened, embossed, eroded, provided with a crackled lacquer or designed as sharkskin or as a lotus leaf surface.

5. The spray conduit as described in claim 3, wherein the microstructure (15) is aligned in the flow direction.

6. A cap (7) comprising a spray bracket (2) integrated in the cap (7) that surrounds a 90° offset spray conduit (10) and having a button (6) for actuating a valve of a container (1), especially an aerosol can or spray can, the button (6) being provided to act against a stem (11) of the container (1) via the 90° offset spray conduit (10) in order to deflect the stem (11) when the button (6) is manually actuated and thereby open the valve, whereupon product contained in the container (1) can exit through the stem (11) and a product discharge opening (3) provided on the cap (7) while passing through the spray conduit (10) and the spray conduit undergoing an acoustic effect, wherein the spray conduit (10) has a texture on its inner surface as described in one of claim 2.
